(19) United States
(12) Patent Application Publication
(10) Pub. No.: US 2009/0071684 A1
(43) Pub. Date: Mar. 19, 2009

(54) HIGH VOLTAGE POWER CABLE TERMINATION

(76) Inventor: Ming Zhang, Shanghai (CN)

Correspondence Address: 3M INNOVATIVE PROPERTIES COMPANY, PO BOX 33427, ST. PAUL, MN, 55133-3427, US

(21) Appl. No.: 12/298,776

(22) PCT Filed: Apr. 20, 2007
(86) PCT No.: PCT/US07/67065

§ 371 Date: Oct. 28, 2008

(30) Foreign Application Priority Data
May 10, 2006 (CN) 200620114298.X

(51) Int. Cl. H02G 15/064

(52) U.S. Cl. 174/73.1

(57) ABSTRACT

The present invention discloses a geometry electrode in a shed stress cone of a high voltage power cable termination, one end of the geometry electrode being leaded into a conductor of the power cable and the other end being leaded into a composite insulator cladding the conductor, the composite insulator having a plurality of shed insulators formed of umbrella shape extending outwards, wherein the geometry electrode has a varying curvature radius along a direction from the conductor of the power cable to the composite insulator, with the curvature radius increasing gradually towards the composite insulator, and the geometry electrode extends at least to the position above the shed insulator. The present invention also discloses a shed stress cone and a high voltage power cable using the geometry electrode. Using the technical solution of the present invention, the same requirements of the electrical property could be satisfied, and the thickness of the composite insulator cladding the geometry electrode could be substantially reduced. Such a design could reduce the manufacturing cost, lower the difficulty of manufacturing, and reduce the time for installation.

### FIELD OF INVENTION

The present invention relates to power cable technology, more particularly, to a high voltage power cable termination, a shed stress cone and a geometric electrode.

### BACKGROUND OF INVENTION

A power cable is widely used for power supply in power distributing networks and power transmission networks, and for transferring electric power from a power plant or a power station to a user in a city or a town. Generally, the power cable is a conductor made of a copper or aluminum material, clad with a multi-layer electric shield and an insulating layer, made of a rubber-plastic material, and further with a metal shielding sheath for transferring ground current and a waterproof sealing enclosure. The power cable is designed to transfer an electric power, the voltage of which ranges from 1000 V to 500 kV.

When the power cable is connected with other electric equipments, necessary treatments should be made to the end of the power cable to ensure persistent and reliable electrical performance and weather tolerance. Usually, cable termination is used for protection of the connection between the end of the cable and other electric equipments.

When the power cable is cut off, the conductor of the cable is exposed to the air, the voltage potential of which is 100% high voltage. The metal shielding enclosure is also exposed to the outside, the voltage potential of which is 0. The rubber-plastic electric shield and the insulating layer between the conductor and the metal shielding enclosure are stripped off by a predetermined distance.

At that time, the stripped conductor, rubber-plastic electric shield and insulating layer, and the metal shielding sheath are faced with such problems as environmental pollution, erosion, etc. After the rubber-plastic electric shield is cut-off, initial continuous distribution of electricity in the cable is destroyed. A phenomenon that electricity is locally concentrated at an open of the rubber-plastic electric shield of the cable will occur. This phenomenon will change the distribution of the electric field, and will increase the possibility that the insulation is destroyed. A cable termination may compensate for the discontinuous distribution of the electric field of the cut off cable, and further provide additional protection of external insulation and weather tolerance.

Generally, there are two technologies of cable termination, oil-type and full-dry-type. In an oil-type cable termination, the insulating portions include an electrical stress control means, insulating liquid and a hollow external insulator for accommodating the insulating liquid and for mechanical protection. A full-dry-type cable termination consists of an electrical stress control means having a particular inner diameter and an external insulator. For a full-dry-type cable termination, there are two methods for electrical stress control, one being a capacitance electrical stress control means and the other being a geometry electrical stress control means. At present, the commonly used geometry means refers to an electrical stress cone. The geometry means controls the concentrated electric field by selections of semiconductive materials and designs of geometry, thereby reducing the larger electric field concentrated at the open of the rubber-plastic electric shield of the cable. In design, the external insulator is apparently a geometric cone, with an electrode made of a semiconductive material disposed therein.

Patent No. ZL00225444.1(CN) discloses a high voltage power cable termination, comprising a rubber insulating shed and a rubber stress enclosure assembly, wherein a stress cone is pre-embedded into a lower portion of the stress enclosure assembly, and the insulating shed covers the stress sheath assembly. Patent No. ZL02250274.2 discloses a high voltage silicon rubber dry-type cable termination, wherein a stress cone structure is also disclosed. A front-end portion of an inner wall of the stress cone is of a flaring taper with an inner diameter thereof increasing forwardly. The flaring taper is embedded into an annular side-wall of a silicon rubber insulating sheath surrounding the cable.

In the outlines of the conventional geometry electrical stress control means as disclosed in the above two patents, there is designed one only geometry taper transiting smoothly (e.g., a flaring taper). Thus, the insulating portions of the geometry electrical stress control means should be made extremely thick to satisfy a certain level of requirements of electric property, e.g., 170 kV, and the thickness of the geometry stress control means approximates 90 millimeters. Further, if the geometry electrical stress control means is too thicker, it will be adverse to installation and production manufacturing.

Further, in the conventional design of the power cable termination, the geometry electrical stress control means does not extend to the position of the shed insulator.

FIG. 1 and FIG. 2 are structural diagrams showing a conventional geometry electrical stress control means and a power cable termination. As shown in FIGS. 1 and 2, an outline 102 of the geometry electrical stress control means 100 (i.e., a geometry electrode) is a geometry taper transiting smoothly, external contour line of the cross-section of which is a straight line (referring to FIG. 1). And, the position the geometry electrical stress control means extends to in the insulator 104 is far from the shed insulator 106 (referring to FIG. 2). That is, the position of the lowest shed insulator 106 is much higher than the position of the geometry electrical stress control means 100. In FIG. 2, the power cable termination is indicated by reference sign 108.

As indicated by experimental data, the electrical property of the geometry electrical stress control means will be apparently affected by the outline shape thereof and the relative distance between the position the geometry electrical stress control means extends to and the shed insulator. Therefore, an object of the present invention is to provide a power cable termination capable of improving its electrical property by changing the outline shape of the geometry electrical stress control means and the relative distance between the position the geometry electrical stress control means extends to and the shed insulator.

### SUMMARY OF INVENTION

The present invention provides a high voltage power cable termination, a shed stress cone and a geometric electrode.

According to a first aspect of the present invention, providing a geometry electrode in a shed stress cone of a high voltage power cable termination, one end of the geometry electrode being leaded into a conductor of the power cable and the other end being leaded into a composite insulator cladding the conductor, the composite insulator having a plurality of shed insulators formed of umbrella shape extending outwards, wherein the geometry electrode has a varying curvature radius along a direction from the conductor of the power cable to the composite insulator, with the curvature radius increasing gradually towards the composite insulator, and the geometry electrode extends at least to the position above the shed insulator.

Preferably, the geometry electrode extends at least to the position above the first shed insulator.

According to a second aspect of the present invention, providing a shed stress cone of a high voltage power cable termination, comprising a composite insulator cladding a conductor of the cable, a plurality of umbrella-shape shed insulators formed by extending the composite insulator outwards, and a geometry electrode, one end of the geometry electrode being leaded into the conductor of the power cable and the other end being leaded into the composite insulator, wherein the geometry electrode has a varying curvature radius along a direction from the conductor of the power cable to the composite insulator, with the curvature radius increasing gradually towards the composite insulator, and the geometry electrode extends at least to the position above the shed insulator.

Preferably, the geometry electrode extends at least to the position above the first shed insulator.

Preferably, the thickness of the composite insulator is thin.

Preferably, the surface of the composite insulator has a small electric field intensity.

According to a third aspect of the present invention, providing a high voltage power cable termination, comprising a conductor of the power cable, a sealing connector, a composite insulator cladding the conductor, a plurality of umbrella-shape shed insulators formed by extending the composite insulator outwards, and a geometry electrode, one end of the geometry electrode being leaded into the conductor of the power cable and the other end being leaded into the composite insulator, wherein the geometry electrode has a varying curvature radius along a direction from the conductor of the power cable to the composite insulator, with the curvature radius increasing gradually towards the composite insulator, and the geometry electrode extends at least to the position above the shed insulator.

Preferably, the geometry electrode extends at least to the position above the first shed insulator.

Preferably, the thickness of the composite insulator is thin.

Preferably, the surface of the composite insulator has a small electric field intensity.

Using the technical solution of the present invention, the geometry electrode and the rubber-plastic shielding layer of the cable are tightly bonded, the condition that the curvature radius at the open of the rubber-plastic shielding layer becomes smaller and the electric field is concentrated as a result of cuffing off the cable, will be gradually magnified by the taper-like geometry electrode and leaded into the inside of the composite insulator, thereby reducing the concentrated distribution of the electric field at the open of the rubber-plastic shielding layer of the cable. Using the technical solution of the present invention, the same requirements of the electrical property could be satisfied, and the thickness of the composite insulator cladding the geometry electrode could be substantially reduced. Such a design could reduce the manufacturing cost, lower the difficulty of manufacturing, and reduce the time for installation. In manufacturing, only the shed insulator, the geometry electrode and the composite insulator are integrally molded.

### BRIEF DESCRIPTION OF THE DRAWINGS

The above described and other features, aspects and advantageous of the present invention will become more apparent from the following detailed description of the embodiments when taken in conjunction with the accompanying drawings, wherein the same elements are represented by the same reference signs throughout the description. In the drawings:

FIG. 1 is a structural diagram showing a conventional geometry electrical stress control means;

FIG. 2 is a structural diagram showing a conventional power cable termination including a geometry electrical stress control means;

FIG. 3 is a structural diagram showing a geometry electrical stress control means according to an embodiment of the present invention; and

FIG. 4 is a structural diagram showing a power cable termination including a geometry electrical stress control means according to an embodiment of the present invention.

### DETAILED DESCRIPTION OF THE PREFERRED EMBODIMENTS

### Geometry Electrode

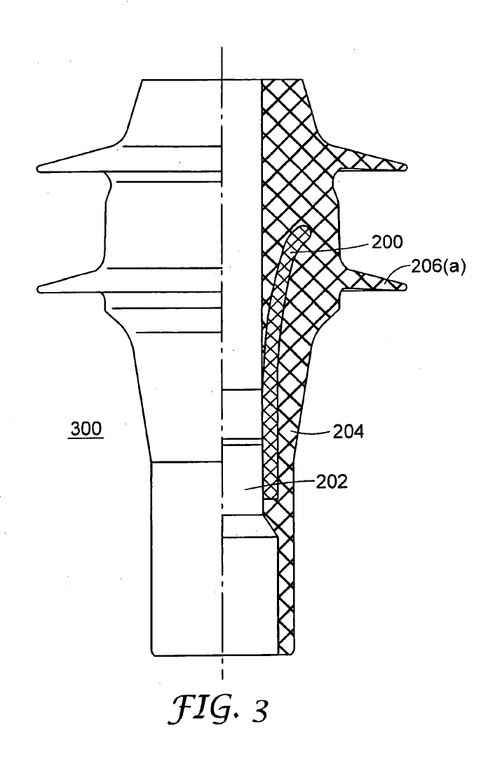

According to an aspect of the present invention, a geometry electrode in a shed stress cone of a high voltage power cable termination is provided. Referring to FIG. 3, FIG. 3 is a structural diagram showing a geometry electrical stress control means according to an embodiment of the present invention. One end of the geometry electrode 200 is leaded into a conductor 202 of the power cable, and the other end is leaded into a composite insulator 204 cladding the conductor. The composite insulator 204 having a plurality of shed insulators 206 formed of umbrella shape extending outwards. The geometry electrode 200 has a varying curvature radius along a direction from the conductor 202 of the power cable to the composite insulator 204, with the curvature radius increasing gradually towards the composite insulator 204. Namely, the external contour line of its cross-section is a curve. And, the geometry electrode 200 extends at least to the position above the first shed insulator 206a. For a person skilled in the art, it is appreciated that the variation of the curvature radius and the position the geometry electrode 200 extends to could be adjusted according to particular applications. For example, the position the geometry electrode 200 extends to could be above the second or higher shed insulator.

Shed Stress Cone

According to a second aspect of the present invention, a shed stress cone of the high voltage power cable termination is provided, which uses the above geometry electrode. As shown in FIG. 3, the shed stress cone 300 comprises the composite insulator 204 cladding the conductor, a plurality of umbrella-shape shed insulators 206 formed by extending the composite insulator outwards, and the geometry electrode 200, one end of which is leaded into the conductor 202 of the power cable and the other end is leaded into the composite insulator 204. The geometry electrode 200 has a varying curvature radius along a direction from the conductor 202 of the power cable to the composite insulator 204, the external contour line of the cross-section of which is a curve, with the curvature radius increasing gradually towards the composite insulator 204. And, the geometry electrode 200 extends at least to the position above the shed insulator. Also, as shown in this embodiment, the geometry electrode 200 extends at least to the position above the first shed insulator 206a. For a person skilled in the art, it is appreciated that the variation of the curvature radius and the position the geometry electrode 200 extends to could be adjusted according to particular applications. For example, the position the geometry electrode 200 extends to could be above the second or higher shed insulator.

By using the above shed stress cone, the composite insulator 204 could be made thinner and there will be a small electric field intensity on the surface of the composite insulator 204.

Power Cable Termination

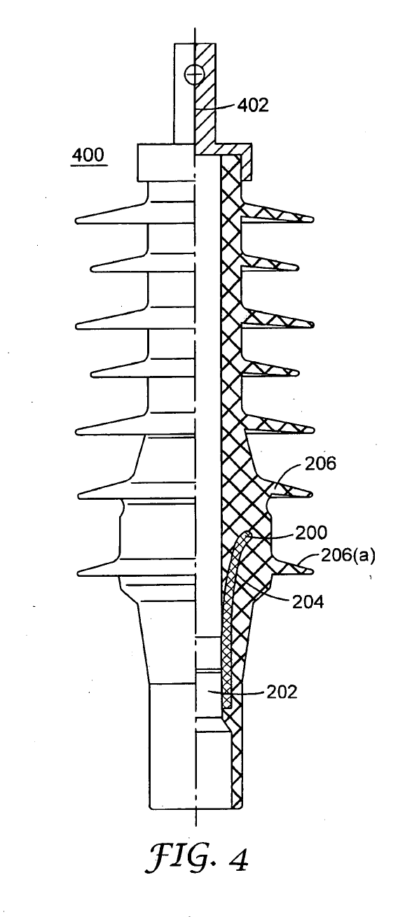

According to a third aspect of the present invention, a high voltage power cable termination is provided, which uses the above shed stress cone. As shown in FIG. 4, the power cable termination 400 comprises the conductor 202 of the power cable, a sealing connector 402, the composite insulator 204 cladding the conductor, a plurality of umbrella-shape shed insulators 206 formed by extending the composite insulator outwards, and the geometry electrode 200, one end of which is leaded into the conductor 202 of the power cable and the other end is leaded into the composite insulator 204. The geometry electrode 200 has a varying curvature radius along a direction from the conductor 202 of the power cable to the composite insulator 204, the external contour line of the cross-section of which is a curve, with the curvature radius increasing gradually towards the composite insulator 204. And, the geometry electrode 200 extends at least to the position above the shed insulator 206. Also, as shown in this embodiment, the geometry electrode 200 extends at least to the position above the first shed insulator 206a. For a person skilled in the art, it is appreciated that the variation of the curvature radius and the position the geometry electrode 200 extends to could be adjusted according to particular applications. For example, the position the geometry electrode 200 extends to could be above the second or higher shed insulator.

By using the above shed stress cone, the composite insulator 204 could be made thinner and there will be a small electric field intensity on the surface of the composite insulator 204.

Experiment Effects

Using the design of the geometry electrode according to the present invention, the same electrical property could be obtained and the composite insulator cladding the geometry electrode could be made substantially thinner. Therefore, manufacturing cost could be reduced, the difficulty of manufacturing could be lowered, and the time for installation could be shortened. In manufacturing, only the shed insulator, the geometry electrode and the composite insulator are integrally molded. In use, the geometry electrode and the rubber-plastic shielding layer of the cable are tightly bonded, the condition that the curvature radius at the open of the rubber-plastic shielding layer becomes smaller and the electric field is concentrated as a result of cuffing off the cable, will be gradually magnified by the taper-like geometry electrode and leaded into the inside of the composite insulator, thereby reducing the concentrated distribution of the electric field at the open of the rubber-plastic shielding layer of the cable.

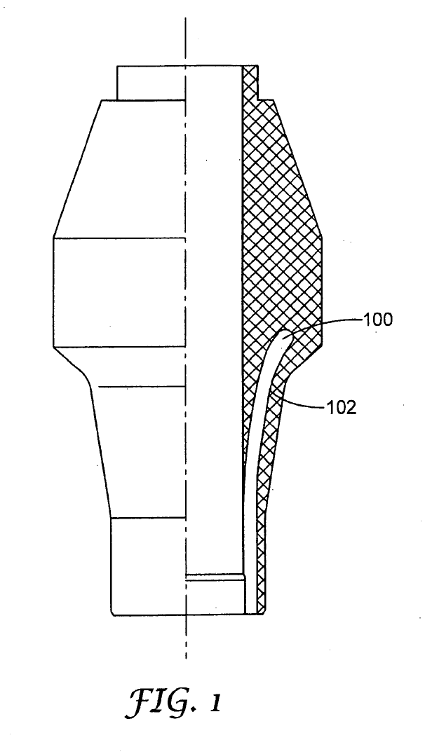

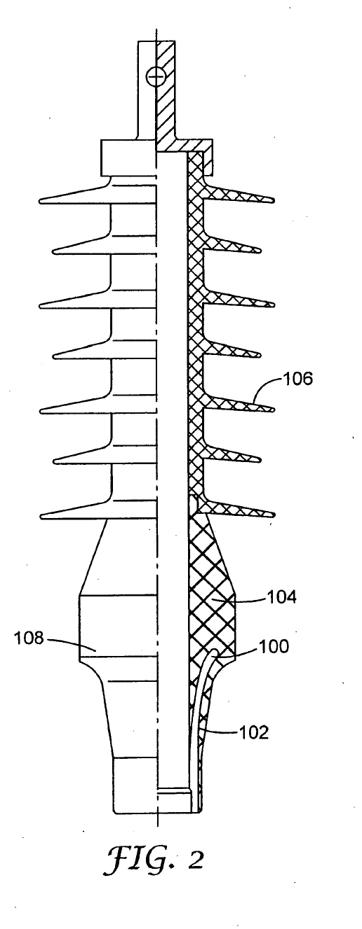

For comparing the effects of the geometry electrode, the shed stress cone and the power cable termination of the present invention with those of the conventional geometry stress control means and the shed stress cone, the following experiment is made. For the different structures used in the prior art as shown in FIGS. 1 and 2 and used in the present invention as shown in FIGS. 3 and 4, a three-dimensional CAD software, Aut0CAD, is used to draw the respective pattern, and then respective pattern is imported into an electric-field calculating software, IES (Integrated Engineering Software) to model a structure installed on a 110 kV power cable, comprising a cable core, a major insulation of the cable, and an external shielding. Also, function parameters for respective materials are set. Then, the structures shown in FIGS. 1 and 2, and in FIGS. 3 and 4 are divided into grids, with the other portions being divided automatically (by reference to the grids of FIGS. 1, 2, 3, and 4). Then, an AC voltage applied on the conductor and the metal shielding of the cable is imported into an analyzing software program. By running the program, solves are obtained by means of finite element numerical method and boundary element numerical method, respectively. As indicated by the result of analysis, using the structure as shown in FIGS. 3 and 4, the largest electric field intensity on the surface of the composite insulator is 7.20 kV/mm; while using the structure as shown in FIGS. 1 and 2, the largest electric field intensity on the surface of the composite insulator is 9.70 kV/mm, which is much larger than the electric field intensity of the structure as shown in FIGS. 3 and 4. That is, in normal use, the electrical property of the structure shown in FIGS. 3 and 4 is much higher than that shown in FIGS. 1 and 2.

Summing up the above, using the technical solution of the present invention, the geometry electrode and the rubber-plastic shielding layer of the cable are tightly bonded, the condition that the curvature radius at the open of the rubber-plastic shielding layer becomes smaller and the electric field is concentrated as a result of cutting off the cable, will be gradually magnified by the taper-like geometry electrode and leaded into the inside of the composite insulator, thereby reducing the concentrated distribution of the electric field at the open of the rubber-plastic shielding layer of the cable. Using the technical solution of the present invention, the same requirements of the electrical property could be satisfied, and the thickness of the composite insulator cladding the geometry electrode could be substantially reduced. Such a design could reduce the manufacturing cost, lower the difficulty of manufacturing, and reduce the time for installation. In manufacturing, only the shed insulator, the geometry electrode and the composite insulator are integrally molded.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A geometry electrode in a shed stress cone of a high voltage power cable termination, one end of the geometry electrode being leaded into a conductor of the power cable and the other end being leaded into a composite insulator cladding the conductor, the composite insulator having a plurality of shed insulators formed of umbrella shape extending outwards, wherein
the geometry electrode has a varying curvature radius along a direction from the conductor of the power cable to the composite insulator, with the curvature radius increasing gradually towards the composite insulator, and
the geometry electrode extends at least to the position above the shed insulator.

2. The geometry electrode according to claim 1, wherein the geometry electrode extends at least to the position above the first shed insulator.

3. A shed stress cone of a high voltage power cable termination, comprising a composite insulator cladding a conductor of the cable, a plurality of umbrella-shape shed insulators formed by extending the composite insulator outwards, and a geometry electrode, one end of the geometry electrode being leaded into the conductor of the power cable and the other end being leaded into the composite insulator, wherein
the geometry electrode has a varying curvature radius along a direction from the conductor of the power cable to the composite insulator, with the curvature radius increasing gradually towards the composite insulator, and
the geometry electrode extends at least to the position above the shed insulator.

4. The geometry electrode according to claim 3, wherein the geometry electrode extends at least to the position above the first shed insulator.

5. The geometry electrode according to claim 4, wherein the thickness of the composite insulator is thin.

6. The geometry electrode according to claim 4, wherein the surface of the composite insulator has a small electric field intensity.

7. A high voltage power cable termination, comprising a conductor of the power cable, a sealing connector, a composite insulator cladding the conductor, a plurality of umbrella-shape shed insulators formed by extending the composite insulator outwards, and a geometry electrode, one end of the geometry electrode being leaded into the conductor of the power cable and the other end being leaded into the composite insulator, wherein
the geometry electrode has a varying curvature radius along a direction from the conductor of the power cable to the composite insulator, with the curvature radius increasing gradually towards the composite insulator, and
the geometry electrode extends at least to the position above the shed insulator.

8-10. (canceled)
